(19) United States
(12) Patent Application Publication
(10) Pub. No.: US 2026/0302906 A1
(43) Pub. Date: Oct. 1, 2026

(54) AXIAL MOTOR

(71) Applicant: JAHWA ELECTRONICS CO., LTD., Cheongju-si (KR)

(72) Inventor: Sun Tae KIM, Cheongju-si (KR)

(73) Assignee: JAHWA ELECTRONICS CO., LTD., Cheongju-si (KR)

(21) Appl. No.: 19/550,353

(22) Filed: Feb. 26, 2026

(30) Foreign Application Priority Data
Mar. 31, 2025 (KR) 10-2025-0041031

(51) Int. Cl. H02K 21/24; H02K 7/08

(52) U.S. Cl. CPC H02K 21/24; H02K 7/083

(57) ABSTRACT

An axial motor includes a plurality of stators arranged in an axial direction, each stator including a plurality of coil assemblies arranged along a circumferential direction intersecting the axial direction, a rotor disposed between the stators, and a shaft extending in the axial direction and penetrating the stators and the rotor, wherein the rotor includes a coupling structure including a core coupled to the shaft and a plurality of bars extending from the core and arranged along the circumferential direction, and a plurality of magnet assemblies disposed between adjacent bars, each magnet assembly including a plurality of first magnets arranged in the axial direction and a second magnet disposed between the first magnets, wherein side surfaces of the second magnet may be exposed to the outside from the first magnets.

### CROSS REFERENCE TO RELATED APPLICATION

The present application is based upon and claims priority to Korean patent application number 10-2025-0041031, filed on Mar. 31, 2025, the entire disclosure of which is incorporated by reference herein.

### TECHNICAL FIELD

The present disclosure relates to an axial motor, and more particularly, to an axial motor that can be easily manufactured and has improved durability.

### BACKGROUND

An axial motor refers to a motor in which a rotor and a stator are arranged in an axial direction of a shaft. Such an axial-winding-type motor also includes a stator configured to form a magnetic field and a rotor configured to be rotatable with respect to the stator. The axial motor generates a rotational torque by switching a direction of a current flowing through coils of the stator, thereby generating a repulsive force or an attractive force between the stator and permanent magnets of the rotor.

The axial motor has a high output density and has a relatively large motor diameter compared to an axial length, thereby allowing a relatively large number of poles to be designed. Accordingly, the axial motor has a structure suitable for high-frequency driving or low-speed driving. In particular, in fields such as urban air mobility (UAM) or electrically propelled aircraft (UAV), an axial motor having a relatively small volume and a light weight is required.

### SUMMARY

An object of the present disclosure is to provide an axial motor that can be easily manufactured.

Another object of the present disclosure is to provide an axial motor having improved durability.

The technical problems of this disclosure are not limited to those mentioned above, and other problems not mentioned will be readily apparent to those skilled in the art from the following description.

An axial motor according to an embodiment of this disclosure includes: a plurality of stators arranged in an axial direction, each stator including a plurality of coil assemblies arranged along a circumferential direction intersecting the axial direction, a rotor disposed between the stators, and a shaft extending in the axial direction and penetrating the stators and the rotor, wherein the rotor includes a coupling structure including a core coupled to the shaft and a plurality of bars extending from the core and arranged along the circumferential direction, and a plurality of magnet assemblies disposed between adjacent bars, each magnet assembly including a plurality of first magnets arranged in the axial direction and a second magnet disposed between the first magnets, wherein side surfaces of the second magnet are exposed to the outside from the first magnets.

An axial motor according to an embodiment of this disclosure includes: a plurality of stators spaced apart from each other in an axial direction, each stator including a plurality of coil assemblies arranged along a circumferential direction intersecting the axial direction, a shaft extending in the axial direction and coupled to the stators, and a rotor coupled to the shaft and disposed between the stators, wherein the rotor includes a coupling structure coupled to the shaft, and a plurality of magnet assemblies coupled to the coupling structure and arranged along a circumferential direction, each magnet assembly including a plurality of first magnets arranged in the axial direction and a second magnet disposed between the first magnets, wherein an area of the second magnet is greater than an area of each of the first magnets when viewed in the axial direction.

According to an embodiment of the present disclosure, sizes of sub-magnets of the second magnet may be relatively increased. Accordingly, manufacturing of a magnet assembly may be facilitated. Therefore, manufacturing of an axial motor may be facilitated.

According to an embodiment of the present disclosure, side surfaces of the second magnet may be exposed to the outside from the first magnets. In addition, when viewed in the axial direction, an area of the second magnet may be equal to or greater than an area of each of the first magnets. Accordingly, even if a magnet assembly is cooled after being exposed to a high temperature, a magnetic force loss rate of the magnet assembly may be reduced. Therefore, durability of the axial motor may be improved.

It should be understood that the effects of this disclosure are not limited to the above-described effects and include all effects that can be inferred from the embodiments and configurations described in the detailed description or in the claims.

### BRIEF DESCRIPTION OF THE DRAWINGS

FIG. 1 is an exploded perspective view of an axial motor according to an embodiment of the present disclosure.

FIG. 2 is an exploded perspective view of the axial motor illustrated in FIG. 1.

FIG. 3 is an exploded perspective view of the rotor illustrated in FIG. 2.

FIG. 4A is a perspective view of a magnet assembly illustrated in FIG. 3.

FIG. 4B is an exploded perspective view of the magnet assembly illustrated in FIG. 4A.

FIG. 5 is a perspective view of a magnet assembly according to a comparative example.

FIG. 6A is a perspective view of a magnet assembly according to a comparative example.

FIG. 6B is an exploded perspective view of the magnet assembly according to the comparative example illustrated in FIG. 6A.

FIG. 6C is another exploded perspective view of the magnet assembly according to the comparative example illustrated in FIG. 6A.

FIG. 7A is an exploded perspective view of a magnet assembly according to a comparative example.

FIG. 7B is an exploded perspective view of a magnet assembly according to a comparative example.

FIG. 8 is a perspective view of a magnet assembly according to an embodiment of the present disclosure.

FIG. 9 is a perspective view of a magnet assembly according to an embodiment of the present disclosure.

### DETAILED DESCRIPTION OF THE EMBODIMENTS

Hereinafter, embodiments of the present disclosure will be described in detail with reference to the accompanying drawings so that a person having ordinary skill in the art to which the present disclosure pertains can readily practice the present disclosure. The present disclosure may be embodied in various different forms and is not limited to the embodiments described herein. For clarity, portions of the drawings that are not relevant to the description are omitted, and the same or similar components are denoted by the same reference numerals throughout the specification.

The words and terms used in this specification and the claims are not to be construed as being limited to their ordinary or dictionary meanings, but are to be interpreted in accordance with meanings and concepts consistent with the technical spirit of the present disclosure, based on principles by which the inventor may define terms and concepts in order to best describe the present disclosure.

Accordingly, the embodiments described in this specification and the configurations illustrated in the drawings correspond to preferred embodiments of the present disclosure and do not represent the entire technical scope of the present disclosure. Therefore, various equivalents and modifications that may substitute for such configurations may exist as of the filing date of the present disclosure.

As used in this specification, the terms “include” and “have” are intended to describe the presence of features, numbers, steps, operations, elements, components, or combinations thereof described herein, and are not intended to preclude the presence or addition of one or more other features, numbers, steps, operations, elements, components, or combinations thereof.

When a component is described as being located at a “front,” “rear,” “upper,” or “lower” position relative to another component, unless otherwise specified, this description includes not only a case in which the component is disposed immediately adjacent to the other component at the front, rear, upper, or lower position, but also a case in which one or more other components are interposed therebetween. In addition, when a component is described as being “connected” to another component, unless otherwise specified, this description includes not only a case of a direct connection between the components, but also a case of an indirect connection through one or more intermediate components.

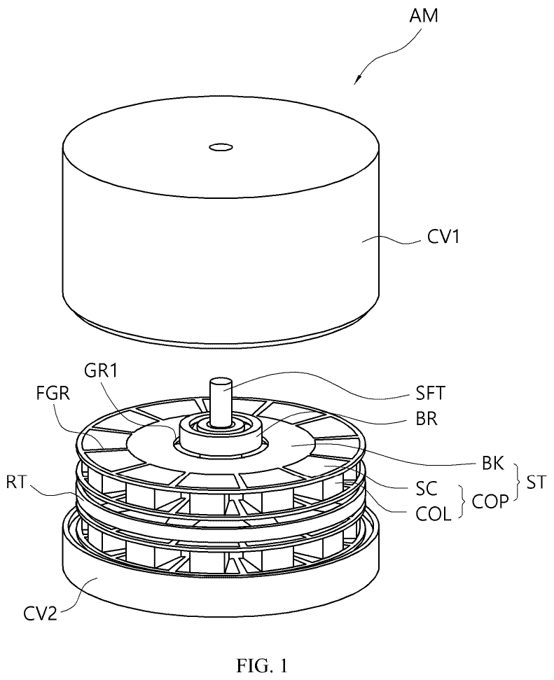

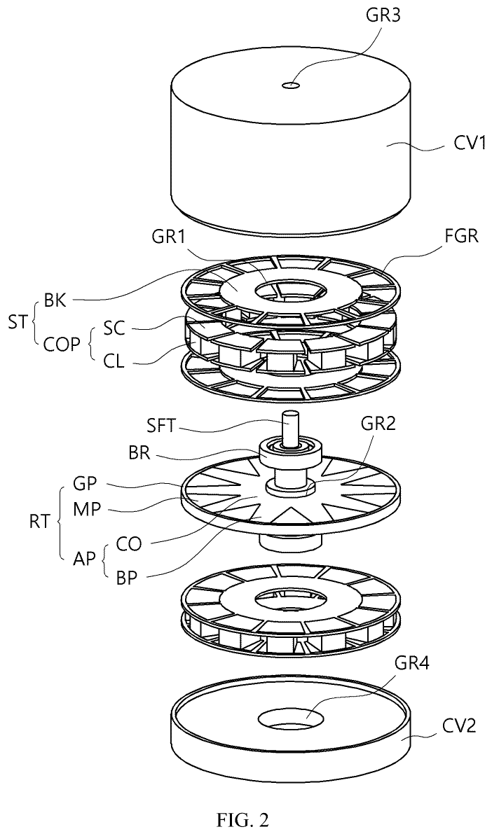

FIG. 1 is an exploded perspective view of an axial motor according to an embodiment of the present disclosure. FIG. 2 is an exploded perspective view of the axial motor illustrated in FIG. 1.

For convenience of description, in FIG. 1, an upper cover CV1 is illustrated in a state separated from a lower cover CV2.

For convenience of description, in FIG. 2, one of a plurality of stators ST is illustrated in an exploded state.

Referring to FIGS. 1 and 2, an axial motor AM may include an upper cover CV1, a lower cover CV2, a shaft SFT, a plurality of stators ST, a rotor RT, and a plurality of bearings BR.

The stators ST may be arranged in an axial direction. The stators ST may be spaced apart from each other by a predetermined interval. The stators ST may form a rotating magnetic field.

The stators ST may include a plurality of coil assemblies COP and a plurality of brackets BK. The coil assemblies COP may be arranged along a circumferential direction intersecting the axial direction. The coil assemblies COP may be spaced apart from each other by a predetermined interval.

The coil assemblies COP may include a plurality of stator cores SC and a plurality of coils CL. The stator cores SC may be arranged along the circumferential direction. The stator cores SC may be spaced apart from each other by a predetermined interval.

Each of the coils CL may be wound around a corresponding one of the stator cores SC. The coils CL may be wound around the stator cores SC to generate magnetic flux in the axial direction.

Each of the brackets BK may define a first groove GR1 and a plurality of fixing grooves FGR. The first groove GR1 may be defined at a central portion of each bracket BK. The first groove GR1 may have a shape corresponding to a circle.

The fixing grooves FGR may be arranged along the circumferential direction. The fixing grooves FGR may surround the first grooves GR1. The fixing grooves FGR may have shapes corresponding to the stator cores SC, respectively.

The brackets BK may include an insulating material. For example, the brackets BK may be formed of ceramic, a thermosetting resin such as Bakelite, or coated stainless steel.

The coil assemblies COP may be coupled to the brackets BK. Each of the stator cores SC may be coupled to a corresponding one of the fixing grooves FGR. The brackets BK may support the coil assemblies COP.

The coil assemblies COP may be coupled to the upper cover CV1 by the brackets BK. Accordingly, when the axial motor AM operates, the coil assemblies COP may not rotate.

The rotor RT may be disposed between the stators ST. A second groove GR2 may be defined in the rotor RT. The second groove GR2 may be defined at the center of the rotor RT. The second groove GR2 may have a circular shape.

The rotor RT may include a plurality of magnet assemblies MP, a coupling structure AP, and a guard GP. The magnet assemblies MP may be arranged along the circumferential direction. Among the magnet assemblies MP, magnet assemblies MP that are adjacent to each other in the circumferential direction may have different polarities. The magnet assemblies MP having different polarities may be alternately arranged along the circumferential direction.

When power is supplied from an external source to the stators ST, a polarity of the coils CL may be sequentially changed by a current flowing into the coils CL, thereby forming a rotating magnetic field. The magnet assemblies MP may interact with the rotating magnetic field to rotate. Accordingly, the rotor RT may rotate.

The coupling structure AP and the guard GP will be described in detail below.

The bearings BR may be disposed between the stators ST and the rotor RT. For example, one of the plurality of bearings BR may be disposed between a stator ST arranged above the rotor RT and the rotor RT. Another one of the plurality of bearings BR may be disposed between a stator ST arranged below the rotor RT and the rotor RT. When the axial motor AM operates, the shaft SFT may smoothly perform rotational motion by the bearings BR.

The shaft SFT may have a rod shape extending in the axial direction. The shaft SFT may extend in the axial direction to penetrate the bearings BR, the rotor RT, and the stators ST. The shaft SFT may be disposed within the first grooves GR1 of the stators ST and penetrate the stators ST.

The shaft SFT may be disposed within the second groove GR2 of the rotor RT and coupled to the rotor RT. Accordingly, when the rotor RT rotates, the shaft SFT may rotate. Rotational force of the rotor RT may be transmitted to the shaft SFT.

The upper cover CV1 may accommodate the shaft SFT, the stators ST, the rotor RT, and the bearings BR in a groove defined therein. A third groove GR3 may be defined on an upper surface of the upper cover CV1. When the upper cover CV1 is coupled to the lower cover CV2, the shaft SFT may be disposed within the third groove GR3. Within the third groove GR3, the shaft SFT may rotate.

The lower cover CV2 may be arranged in the axial direction with respect to the upper cover CV1. The lower cover CV2 may be disposed below the upper cover CV1. The lower cover CV2 may be coupled to the upper cover CV1. The lower cover CV2 may be coupled to the upper cover CV1 to provide a receiving space.

A fourth groove GR4 may be defined in the lower cover CV2. The shaft SFT may be disposed within the fourth groove GR4. The shaft SFT may rotate within the fourth groove GR4.

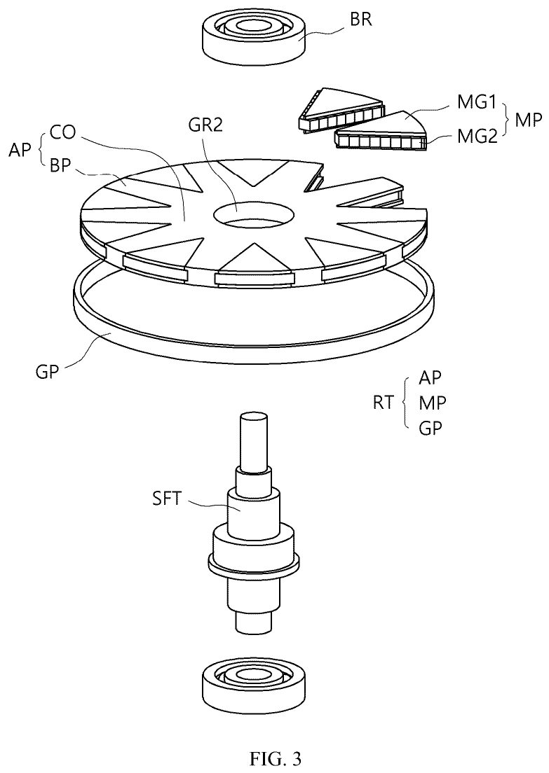

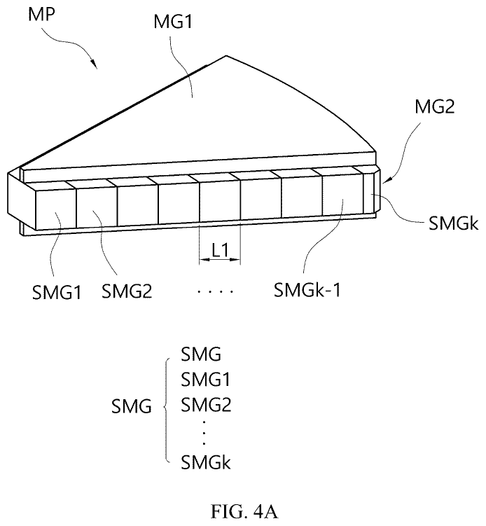

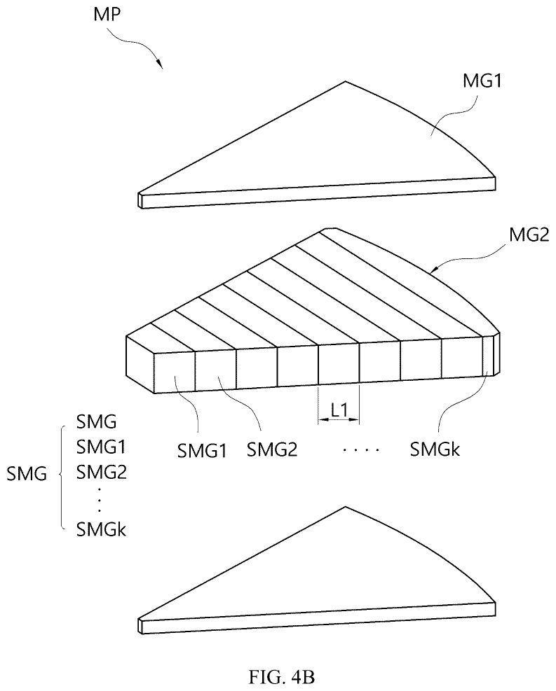

FIG. 3 is an exploded perspective view of the rotor illustrated in FIG. 2. FIG. 4A is a perspective view of a magnet assembly illustrated in FIG. 3. FIG. 4B is an exploded perspective view of the magnet assembly illustrated in FIG. 4A.

For convenience of description, in FIGS. 4A and 4B, only one of the plurality of magnet assemblies MP illustrated in FIG. 3 is illustrated. However, the remaining magnet assemblies MP illustrated in FIG. 3 may have substantially the same structure.

Referring to FIGS. 3 to 4B, descriptions of elements identical to those described above will be omitted or briefly described.

Referring to FIGS. 2 and 3, the rotor RT may include magnet assemblies MP, a coupling structure AP, and a guard GP. The coupling structure AP may include a core CO and a plurality of bars BP.

The core CO may have a disk shape. The second groove GR2 may be defined at the center of the core CO. The shaft SFT may be disposed within the second groove GR2. The core CO may be coupled to the shaft SFT.

The bars BP may extend radially outward from a periphery of the core CO. The bars BP may be arranged along the circumferential direction. The bars BP may surround the core CO. The bars BP may be arranged to be spaced apart from each other in the circumferential direction. Substantially, the bars BP and the core CO may be integrally formed.

The magnet assemblies MP may be disposed between adjacent bars BP. The magnet assemblies MP may be detachably coupled to the bars BP. The magnet assemblies MP may be arranged along the circumferential direction. The magnet assemblies MP may be arranged to be spaced apart from each other in the circumferential direction.

Among the magnet assemblies MP, polarities of magnet assemblies MP that are adjacent to each other may be different from each other. For example, magnet assemblies MP having a first polarity and magnet assemblies MP having a second polarity may be alternately arranged along the circumferential direction. Magnet assemblies MP having the second polarity may be disposed adjacent, in the circumferential direction, to magnet assemblies MP having the first polarity. The first polarity may be defined as an N pole, and the second polarity may be defined as an S pole.

Referring to FIGS. 4A and 4B, the magnet assembly MP may include a plurality of first magnets MG1 and a second magnet MG2. The first magnets MG1 may be arranged in the axial direction. For example, the first magnets MG1 may have a fan shape.

The first magnets MG1 may be bonded magnets. A bonded magnet may be defined as a magnet formed by mixing a magnetic powder, such as ferrite, with a binder such as rubber or plastic and molding the mixture. The bonded magnet may be manufactured by kneading a rubber or plastic material with the magnetic powder and then molding the mixture in a magnetic field, or by molding the mixture by mechanical means.

The second magnet MG2 may be disposed between the first magnets MG1. The second magnet MG2 may be a sintered magnet. The sintered magnet may be defined as a permanent magnet manufactured by powder metallurgy, in which a magnetic powder such as a rare-earth magnetic powder is sintered at a high temperature. The second magnet MG2 may have stronger magnetic properties than the first magnets MG1. The second magnet MG2 may have higher electrical conductivity than the first magnets MG1. The first magnets MG1 may have higher electrical resistance than the second magnet MG2.

When viewed in the axial direction, an area of the second magnet MG2 may be greater than that of the first magnets MG1. A periphery of the second magnet MG2 may be disposed outward of peripheries of the first magnets MG1. Side surfaces of the second magnet MG2 may be exposed to the outside from the first magnets MG1. Hereinafter, “when viewed in the axial direction” may be defined as a state viewed in a plan view.

When the magnet assembly MP does not include the first magnets MG1, eddy current loss may occur in the second magnet MG2 when the rotor RT rotates. Accordingly, a temperature of the second magnet MG2 may increase. Thereafter, when the second magnet MG2 is cooled, magnetic properties of the second magnet MG2 may be reduced. As a result, performance of the axial motor AM illustrated in FIG. 1 may be degraded.

However, the magnet assembly MP according to an embodiment of the present disclosure includes the first magnets MG1, which are bonded magnets, thereby preventing a reduction in magnetic properties of the second magnets MG2 due to eddy current loss. Accordingly, durability of the axial motor AM illustrated in FIG. 1 may be improved. This will be described in detail below.

The second magnet MG2 may include a plurality of sub-magnets SMG. For example, the second magnet MG2 may include k sub-magnets SMG. The sub-magnets SMG may be insulated-coated magnets. Here, k may be defined as a natural number greater than 1.

As the second magnet MG2 includes the plurality of sub-magnets SMG, eddy current flowing collectively may be prevented. Accordingly, loss due to eddy current may be reduced.

The k sub-magnets SMG may be arranged in a radial direction. Among the sub-magnets SMG, sub-magnets SMG other than a k-th sub-magnet SMGk may have the same width in the radial direction as the first magnets MG1. A first length L1 may be defined as a width, in the radial direction, of each of a first sub-magnet SMG1 to a (k−1)-th sub-magnet SMGk−1. The width of each of the first sub-magnet SMG1 to the (k−1)-th sub-magnet SMGk−1 may be the first length L1. A width of the k-th sub-magnet SMGk in the radial direction may be smaller than the first length L1 of the (k−1)-th sub-magnet SMGk−1.

When viewed in the axial direction, upper surfaces of the sub-magnets SMG may have different areas. When viewed in the axial direction, an area of a k-th sub-magnet SMGk in a radial order may be greater than an area of a (k−1)-th sub-magnet SMGk−1. For example, among the sub-magnets SMG, an area of a first sub-magnet SMG1 may be smaller than an area of the k-th sub-magnet SMGk. Accordingly, in FIG. 3, even if a distance between adjacent bars BP increases as the distance from the core CO increases, the second magnet MG2 may be coupled to the bars BP.

Referring to FIGS. 2 and 3, the guard GP may have an annular shape. The guard GP may surround the magnet assemblies MP and the coupling structure AP.

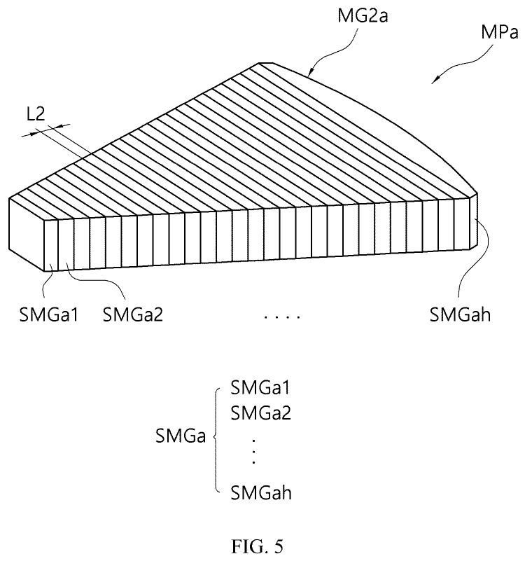

FIG. 5 is a perspective view of a magnet assembly according to a comparative example.

Referring to FIG. 5, a magnet assembly MPa according to a comparative example may include a second magnet MG2a. The magnet assembly MPa may not include first magnets MG1.

The second magnet MG2a may include h sub-magnets SMGa. The h sub-magnets SMGa may be coated magnets. The h sub-magnets SMGa may be arranged in a radial direction. The h may be defined as a natural number greater than k of FIG. 4B.

Except for an h-th sub-magnet SMGah, a radial width of each of first sub-magnets SMGa1 to (h−1)-th sub-magnets SMGah−1 may be defined as a second length L2.

When external power is applied to the axial motor AM (see FIG. 1) and the axial motor AM operates, eddy current loss may occur in the magnet assembly MPa. After a temperature of the second magnet MGa increases due to the eddy current loss and the second magnet MGa is cooled, magnetic properties of the second magnet MGa may be reduced.

To prevent this, the second magnet MGa may be divided into a plurality of sub-magnets SMGa. The number h and a loss of magnetic flux due to eddy current may be inversely proportional to each other. That is, as the number h increases, the loss of magnetic flux due to eddy current may be reduced. However, as a second length L2 of the sub-magnets SMGa decreases, manufacturing of the second magnet MG2a becomes less easy, and manufacturing cost may increase.

Referring to FIGS. 4B and 5, a width of a (k−1)-th sub-magnet SMGk−1 may be greater than a width of an (h−1)-th sub-magnet SMGah−1. The first length L1 may be greater than the second length L2.

According to an embodiment of the present disclosure, the second magnet MG2 may be disposed between the first magnets MG1. Even if the first length L1 is greater than the second length L2, since the second magnet MG2 is disposed between the first magnets MG1 having relatively low electrical resistance, a loss of magnetic flux due to eddy current may be reduced. Accordingly, manufacturing of the second magnet MG2 may be facilitated.

Although not illustrated, when the magnet assembly MP includes only the first magnets MG1 without including the second magnet MG2, magnetism of the magnet assembly MP may be reduced, and performance of the axial motor AM (see FIG. 1) may be degraded. In addition, in order to achieve performance equivalent to that of the axial motor AM (see FIG. 1) including the embodiment according to FIG. 5, a size of the first magnets MG1 may be increased. Accordingly, a size and a weight of the axial motor AM (see FIG. 1) may be increased. Therefore, the axial motor AM (see FIG. 1) may not be suitable for urban air mobility (UAM) or electrically propelled aircraft (UAV).

However, the magnet assembly MP according to an embodiment of the present disclosure may prevent a reduction in magnetic flux without an increase in size and weight. Accordingly, a weight and a volume of the axial motor AM (see FIG. 1) may be reduced.

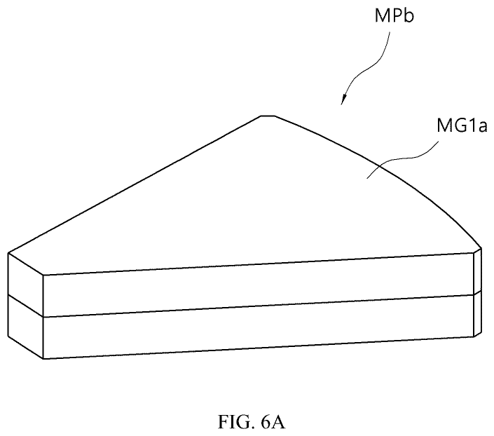

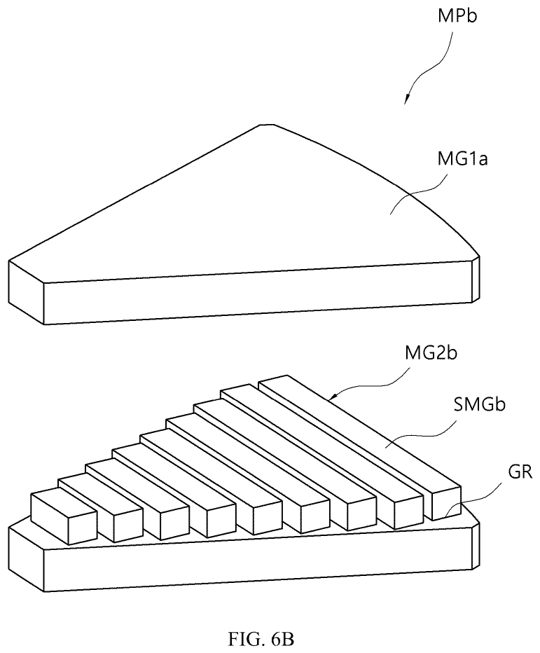

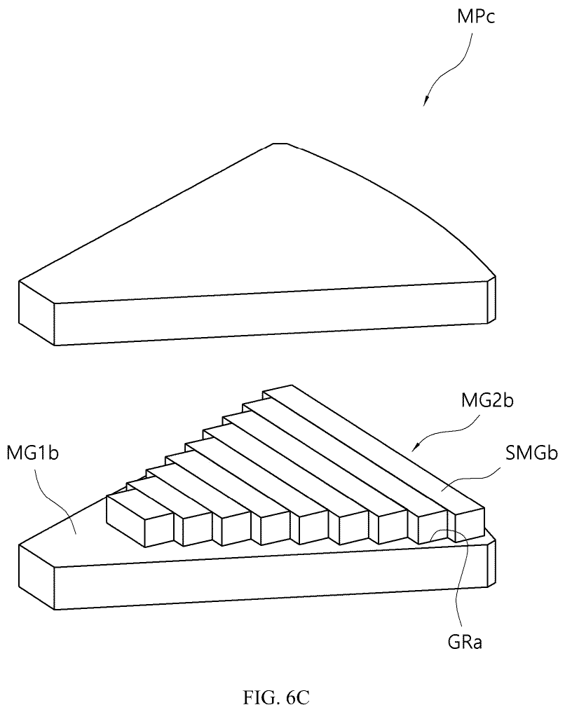

FIG. 6A is a perspective view of a magnet assembly according to a comparative example. FIG. 6B is an exploded perspective view of the magnet assembly according to the comparative example illustrated in FIG. 6A. FIG. 6C is another exploded perspective view of the magnet assembly according to the comparative example illustrated in FIG. 6A.

For convenience of description, magnet assemblies MPb and MPc of FIGS. 6B and 6C are illustrated in a state in which first magnets MG1a and MG1b disposed at an upper side among the first magnets MG1a and MG1b are disassembled.

Among components illustrated in FIGS. 6A to 6C, descriptions of components identical to those described above with reference to the foregoing drawings will be omitted or briefly described.

Referring to FIGS. 6A and 6B, the second magnet MG2b may include a plurality of sub-magnets SMGb. The sub-magnets SMGb may have a rectangular parallelepiped shape. Since the sub-magnets SMGb of FIGS. 6B and 6C are substantially identical to the sub-magnets of FIG. 4A except for shapes thereof, a detailed description thereof will be omitted.

A plurality of grooves GR may be defined on mutually facing sides of first magnets MG1a that face each other in the axial direction. The grooves GR may be arranged in a radial direction. However, the present disclosure is not limited thereto, and the grooves GR may be continuously defined in the radial direction. That is, as illustrated in FIG. 6C, a single groove GRa may be defined in the first magnets MG1b.

The grooves GR may have shapes corresponding to the sub-magnets SMGa. For example, the grooves GR may have shapes corresponding to portions of a rectangular parallelepiped.

Each of the sub-magnets SMGb may be disposed in a corresponding groove GR among the grooves GR. When the plurality of first magnets MG1a are in contact with each other, the first magnets MG1a and MG1b may cover side surfaces of the sub-magnets SMGb. Accordingly, the sub-magnets SMGb may not be exposed to the outside from the first magnets MG1a.

Referring to FIGS. 4A, 6B, and 6C, sub-magnets SMGb and SMGc according to a comparative example may not be exposed to the outside. Accordingly, when the axial motor AM (see FIG. 1) operates, a loss of magnetic flux due to eddy current in magnet assemblies MPb and MPc may be greater than a loss of magnetic flux of the magnet assembly MP according to an embodiment of the present disclosure.

TABLE 1

| | Flux at | | | | | | |
|---|---|---|---|---|---|---|---|
| | room | Experiment 1 | | Experiment 2 | | Experiment 3 | |
| | temperature | Flux | Loss rate | Flux | Loss rate | Flux | Loss rate |
| | (mWb) | (mWb) | (%) | (mWb) | (%) | (mWb) | (%) |
| MP | 168.61 | 168.31 | 0.18 | 167.7 | 0.54 | 166.71 | 1.13 |
| MPa | 130.04 | 129.77 | 0.21 | 129.58 | 0.35 | 129.32 | 0.55 |
| MPb | 139.82 | 124.45 | 10.99 | 117.75 | 15.78 | 110.94 | 20.66 |
| MPc | 158.15 | 149.31 | 5.59 | 144.05 | 8.92 | 137.74 | 12.91 |

Table 1 shows data obtained by measuring magnetic flux and a reduction ratio of magnetic flux of a magnet assembly MP according to an embodiment of the present disclosure and magnet assemblies MPb and MPc according to comparative examples. Room temperature may be defined as 20° C. Experiment 1 may be an experiment in which the magnet assemblies MP, MPa, MPb, and MPc are heated at 80° C. for 2 hours and then cooled to 20° C. Experiment 2 may be an experiment in which the magnet assemblies MP, MPa, MPb, and MPc are heated at 100° C. for 2 hours and then cooled to 20° C. Experiment 3 may be an experiment in which the magnet assemblies MP, MPa, MPb, and MPc are heated at 120° C. for 2 hours and then cooled to 20° C. A loss rate may be defined as a ratio of a change in magnetic flux to magnetic flux of the magnet assemblies MP, MPa, MPb, and MPc measured at room temperature.

The magnet assembly MP may have a magnetic flux of 168.61 mWb at room temperature. The magnet assembly MPa according to FIG. 5 may have a magnetic flux of 130.04 mWb at room temperature. The magnet assembly MPb according to FIG. 6B may have a magnetic flux of 139.82 mWb at room temperature. The magnet assembly MPc according to FIG. 6C may have a magnetic flux of 158.15 mWb at room temperature.

According to Experiment 1, when the magnet assembly MP is heated to 80° C. for 2 hours and then cooled to 20° C., the magnet assembly MP may have a magnetic flux of 168.31 mWb. A magnetic flux of the magnet assembly MP may be reduced by 0.18%. When the magnet assembly MPa according to FIG. 5 is heated to 80° C. for 2 hours and then cooled to 20° C., the magnet assembly MPa may have a magnetic flux of 129.77 mWb. A magnetic flux of the magnet assembly MPa may be reduced by 0.21%. When the magnet assembly MPb according to FIG. 6B is heated to 80° C. for 2 hours and then cooled to 20° C., the magnet assembly MPb may have a magnetic flux of 124.45 mWb. A magnetic flux of the magnet assembly MPb may be reduced by 10.99%. When the magnet assembly MPc according to FIG. 6C is heated to 80° C. for 2 hours and then cooled to 20° C., the magnet assembly MPc may have a magnetic flux of 149.31 mWb. A magnetic flux of the magnet assembly MPc may be reduced by 5.59%. From Experiment 1, it may be confirmed that a loss rate of the magnet assembly MP according to an embodiment of the present disclosure is closest to a loss rate of the magnet assembly MPa of FIG. 5.

According to Experiment 2, when the magnet assembly MP is heated to 100° C. for 2 hours and then cooled to 20° C., the magnet assembly MP may have a magnetic flux of 167.7 mWb. A magnetic flux of the magnet assembly MP may be reduced by 0.54%. When the magnet assembly MPa according to FIG. 5 is heated to 100° C. for 2 hours and then cooled to 20° C., the magnet assembly MPa may have a magnetic flux of 129.58 mWb. A magnetic flux of the magnet assembly MPa may be reduced by 0.35%. When the magnet assembly MPb according to FIG. 6B is heated to 100° C. for 2 hours and then cooled to 20° C., the magnet assembly MPb may have a magnetic flux of 117.75 mWb. A magnetic flux of the magnet assembly MPb may be reduced by 15.78%. When the magnet assembly MPc according to FIG. 6C is heated to 100° C. for 2 hours and then cooled to 20° C., the magnet assembly MPc may have a magnetic flux of 144.05 mWb. A magnetic flux of the magnet assembly MPc may be reduced by 8.92%. From Experiment 2, it may be confirmed that a loss rate of the magnet assembly MP according to an embodiment of the present disclosure is closest to a loss rate of the magnet assembly MPa of FIG. 5.

According to Experiment 3, when the magnet assembly MP is heated to 120° C. for 2 hours and then cooled to 20° C., the magnet assembly MP may have a magnetic flux of 166.71 mWb. A magnetic flux of the magnet assembly MP may be reduced by 1.13%. When the magnet assembly MPa according to FIG. 5 is heated to 120° C. for 2 hours and then cooled to 20° C., the magnet assembly MPa may have a magnetic flux of 129.32 mWb. A magnetic flux of the magnet assembly MPa may be reduced by 0.55%. When the magnet assembly MPb according to FIG. 6B is heated to 120° C. for 2 hours and then cooled to 20° C., the magnet assembly MPb may have a magnetic flux of 110.94 mWb. A magnetic flux of the magnet assembly MPb may be reduced by 20.66%. When the magnet assembly MPc according to FIG. 6C is heated to 120° C. for 2 hours and then cooled to 20° C., the magnet assembly MPc may have a magnetic flux of 137.74 mWb. A magnetic flux of the magnet assembly MPc may be reduced by 12.91%. From Experiment 3, it may be confirmed that a loss rate of the magnet assembly MP according to an embodiment of the present disclosure is closest to a loss rate of the magnet assembly MPa of FIG. 5.

As confirmed through Experiments 1 to 3, since side surfaces of the sub-magnets SMG according to an embodiment of the present disclosure are exposed to the outside from the first magnets MG1, a loss rate of the magnet assembly MP according to an embodiment of the present disclosure may be closest to a loss rate of the magnet assembly MPa of FIG. 5. Accordingly, manufacturing may be facilitated, and a loss rate of the magnet assembly MP due to eddy current may be reduced. Therefore, durability of the axial motor AM of FIG. 1 may be improved.

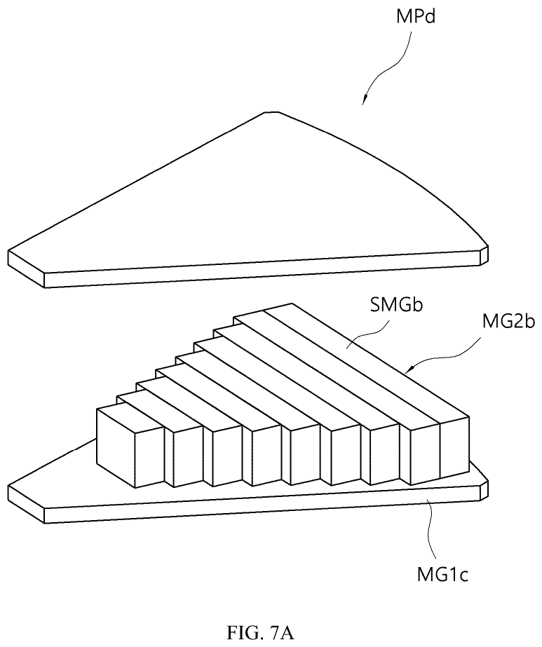

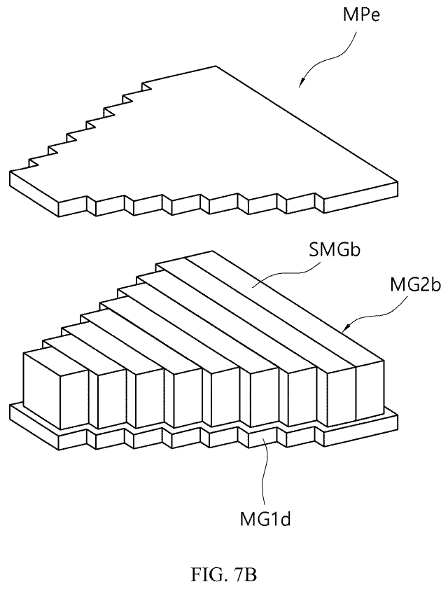

FIG. 7A is an exploded perspective view of a magnet assembly according to a comparative example. FIG. 7B is an exploded perspective view of a magnet assembly according to a comparative example.

For example, among first magnets MG1c and MG1d illustrated in FIGS. 7A and 7B, first magnets MG1c and MG1d disposed at an upper side are illustrated in a state separated from second magnets MG2b.

Among components illustrated in FIGS. 7A and 7B, descriptions of components identical to those described above with reference to the foregoing drawings will be omitted or briefly described.

Referring to FIG. 7A, the magnet assembly MPd may include first magnets MG1c and a second magnet MG2b. The first magnets MG1c may cover an upper surface and a lower surface of the second magnet MG2b. The first magnets MG1c may not cover side surfaces of the second magnet MG2b. Accordingly, sub-magnets SMGb of the second magnet MG2b may be exposed to the outside from the first magnets MG1c.

When viewed in the axial direction, an area of each of the first magnets MG1c may be greater than an area of the second magnet MG2b. A total sum of areas of the sub-magnets SMGb may be smaller than an area of one of the first magnets MG1c. When viewed in the axial direction, a periphery of the second magnet MG2b may be disposed inward of peripheries of the first magnets MG1c. When viewed in the axial direction, the peripheries of the first magnets MG1c may surround the periphery of the second magnet MG2b.

Referring to FIG. 7B, the magnet assembly MPe may include first magnets MG1d and a second magnet MG2b. Sides of the first magnets MG1d located at opposite circumferential positions may have stepped portions. When viewed in the axial direction, the sides of the first magnets MG1d located at opposite circumferential positions may have shapes corresponding to a periphery of the second magnet MG2b.

The first magnets MG1d may cover an upper surface and a lower surface of the second magnet MG2b. The first magnets MG1d may not cover side surfaces of the second magnet MG2b. Accordingly, sub-magnets SMGb of the second magnet MG2b may be exposed to the outside from the first magnets MG1d.

An area of each of the first magnets MG1d may be greater than an area of the second magnet MG2b. A total sum of areas of the sub-magnets SMGb may be smaller than an area of one of the first magnets MG1d. When viewed in the axial direction, a periphery of the second magnet MG2b may be disposed inward of peripheries of the first magnets MG1d. When viewed in the axial direction, the peripheries of the first magnets MG1d may surround the second magnet MG2b.

Referring to FIGS. 4A, 7A, and 7B, since an area of second magnets MG2b according to comparative examples is smaller than an area of first magnets MG1c and MG1d, when the axial motor AM (see FIG. 1) operates, a loss of magnetic flux due to eddy current of magnet assemblies MPd and MPe may be greater than a loss of magnetic flux of the magnet assembly MP according to an embodiment of the present disclosure.

TABLE 2

| | Flux at room | Experiment 4 | | Experiment 5 | |
|---|---|---|---|---|---|
| | temperature | Flux | Loss | Flux | Loss |
| | (mWb) | (mWb) | rate (%) | (mWb) | rate (%) |
| MP | 168.61 | 167.7 | 0.54 | 166.71 | 1.13 |
| MPa | 130.04 | 129.77 | 0.21 | 129.58 | 0.35 |
| MPd | 130.34 | 124.82 | 4.24 | 121.93 | 6.45 |
| MPe | 117.15 | 115.76 | 1.19 | 114.54 | 2.23 |

Table 2 shows data obtained by measuring magnetic flux and a reduction ratio of magnetic flux of a magnet assembly MP according to an embodiment of the present disclosure and magnet assemblies MPd and MPe according to comparative examples. Room temperature may be defined as 20° C. Experiment 4 may be an experiment in which the magnet assemblies MP, MPa, MPd, and MPe are heated at 100° C. for 2 hours and then cooled to 20° C. Experiment 5 may be an experiment in which the magnet assemblies MP, MPa, MPd, and MPe are heated at 120° C. for 2 hours and then cooled to 20° C. A loss rate may be defined as a ratio of a change in magnetic flux to magnetic flux of the magnet assemblies MP, MPa, MPd, and MPe measured at room temperature.

The magnet assembly MPd according to FIG. 7A may have a magnetic flux of 130.34 mWb at room temperature. The magnet assembly MPe according to FIG. 7B may have a magnetic flux of 117.15 mWb at room temperature.

According to Experiment 4, when the magnet assembly MP is heated to 100° C. for 2 hours and then cooled to 20° C., the magnet assembly MP may have a magnetic flux of 167.7 mWb. A magnetic flux of the magnet assembly MP may be reduced by 0.54%. When the magnet assembly MPa according to FIG. 5 is heated to 100° C. for 2 hours and then cooled to 20° C., the magnet assembly MPa may have a magnetic flux of 129.58 mWb. When the magnet assembly MPd according to FIG. 7A is heated to 100° C. for 2 hours and then cooled to 20° C., the magnet assembly MPd may have a magnetic flux of 124.82 mWb. A magnetic flux of the magnet assembly MPd may be reduced by 4.24%. When the magnet assembly MPe according to FIG. 7B is heated to 100° C. for 2 hours and then cooled to 20° C., the magnet assembly MPe may have a magnetic flux of 115.76 mWb. A magnetic flux of the magnet assembly MPe may be reduced by 1.19%. From Experiment 4, it may be confirmed that a loss rate of the magnet assembly MP according to an embodiment of the present disclosure is closest to a loss rate of the magnet assembly MPa of FIG. 5.

According to Experiment 5, when the magnet assembly MP is heated to 120° C. for 2 hours and then cooled to 20° C., the magnet assembly MP may have a magnetic flux of 166.71 mWb. A magnetic flux of the magnet assembly MP may be reduced by 1.13%. When the magnet assembly MPa according to FIG. 5 is heated to 120° C. for 2 hours and then cooled to 20° C., the magnet assembly MPa may have a magnetic flux of 129.32 mWb. A magnetic flux of the magnet assembly MPa may be reduced by 0.35%. When the magnet assembly MPd according to FIG. 7A is heated to 120° C. for 2 hours and then cooled to 20° C., the magnet assembly MPd may have a magnetic flux of 121.93 mWb. A magnetic flux of the magnet assembly MPd may be reduced by 6.45%. When the magnet assembly MPe according to FIG. 7B is heated to 120° C. for 2 hours and then cooled to 20° C., the magnet assembly MPe may have a magnetic flux of 114.54 mWb. A magnetic flux of the magnet assembly MPe may be reduced by 2.23%. From Experiment 5, it may be confirmed that a loss rate of the magnet assembly MP according to an embodiment of the present disclosure is closest to a loss rate of the magnet assembly MPa of FIG. 5.

As confirmed through Experiments 4 and 5, when viewed in the axial direction, since an area of the second magnet MG2 according to an embodiment of the present disclosure is greater than an area of each of the first magnets MG1, a loss rate of the magnet assembly MP according to an embodiment of the present disclosure may be closest to a loss rate of the magnet assembly MPa of FIG. 5. Accordingly, manufacturing may be facilitated, and a loss rate of the magnet assembly MP due to eddy current may be reduced. Therefore, durability of the axial motor AM of FIG. 1 may be improved.

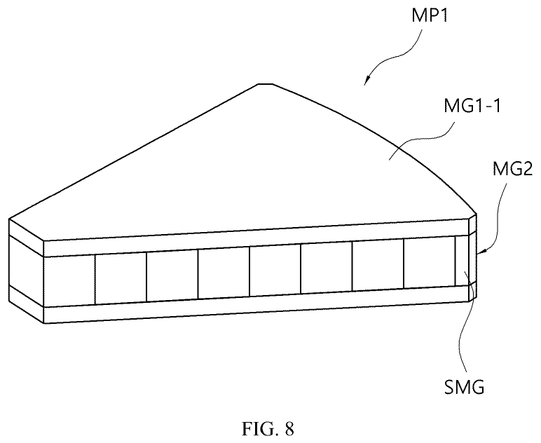

FIG. 8 is a perspective view of a magnet assembly according to an embodiment of the present disclosure.

Among components illustrated in FIG. 8, descriptions of components identical to those described above with reference to the foregoing drawings will be omitted or briefly described.

Referring to FIG. 8, a magnet assembly MP1 may include first magnets MG1-1 and a second magnet MG2. When viewed in the axial direction, an area of the second magnet MG2 may be equal to an area of each of the first magnets MG1-1. When viewed in the axial direction, a periphery of the second magnet MG2 and peripheries of the first magnets MG1-1 may be aligned with each other.

TABLE 3

| | Flux at room | Experiment 6 | | Experiment 7 | |
|---|---|---|---|---|---|
| | temperature | Flux | Loss | Flux | Loss |
| | (mWb) | (mWb) | rate (%) | (mWb) | rate (%) |
| MP1 | 183.18 | 181.44 | 0.95 | 179.35 | 2.09 |
| MPb | 139.82 | 117.75 | 15.78 | 110.94 | 20.66 |
| MPc | 158.15 | 144.05 | 8.92 | 137.74 | 12.91 |
| MPd | 130.34 | 124.82 | 4.24 | 121.93 | 6.45 |
| MPe | 117.15 | 115.76 | 1.19 | 114.54 | 2.23 |

Referring to FIGS. 6B, 6C, 7A, 7B, and 8, Table 3 shows data obtained by measuring magnetic flux and a reduction ratio of magnetic flux of a magnet assembly MP1 according to an embodiment of the present disclosure and magnet assemblies MPb, MPc, MPd, and MPe according to comparative examples. Room temperature may be defined as 20° C. Experiment 6 may be an experiment in which the magnet assemblies MP1, MPb, MPc, MPd, and MPe are heated at 100° C. for 2 hours and then cooled to 20° C. Experiment 7 may be an experiment in which the magnet assemblies MP1, MPb, MPc, MPd, and MPe are heated at 120° C. for 2 hours and then cooled to 20° C. A loss rate may be defined as a ratio of a change in magnetic flux to magnetic flux of the magnet assemblies MP1, MPb, MPc, MPd, and MPe measured at room temperature. The magnet assembly MP1 according to an embodiment of the present disclosure may have a magnetic flux of 183.18 mWb at room temperature.

According to Experiment 6, the magnet assembly MP1 according to an embodiment of the present disclosure may have a magnetic flux of 181.44 mWb when heated at 100° C. for 2 hours and then cooled to 20° C. A magnetic flux of the magnet assembly MP1 may be reduced by 0.95%. When the magnet assembly MPb according to FIG. 6B is heated at 100° C. for 2 hours and then cooled to 20° C., the magnet assembly MPb may have a magnetic flux of 117.75 mWb. A magnetic flux of the magnet assembly MPb may be reduced by 15.78%. When the magnet assembly MPc according to FIG. 6C is heated at 100° C. for 2 hours and then cooled to 20° C., the magnet assembly MPc may have a magnetic flux of 144.05 mWb. A magnetic flux of the magnet assembly MPc may be reduced by 8.92%. When the magnet assembly MPd according to FIG. 7A is heated at 100° C. for 2 hours and then cooled to 20° C., the magnet assembly MPd may have a magnetic flux of 124.82 mWb. A magnetic flux of the magnet assembly MPd may be reduced by 4.24%. When the magnet assembly MPe according to FIG. 7B is heated at 100° C. for 2 hours and then cooled to 20° C., the magnet assembly MPe may have a magnetic flux of 115.76 mWb. A magnetic flux of the magnet assembly MPe may be reduced by 1.19%. From Experiment 6, it may be confirmed that a magnetic flux loss rate of the magnet assembly MP1 according to an embodiment of the present disclosure is the smallest.

According to Experiment 7, the magnet assembly MP1 according to an embodiment of the present disclosure may have a magnetic flux of 179.35 mWb when heated at 120° C. for 2 hours and then cooled to 20° C. A magnetic flux of the magnet assembly MP1 may be reduced by 2.09%. When the magnet assembly MPb according to FIG. 6B is heated at 120° C. for 2 hours and then cooled to 20° C., the magnet assembly MPb may have a magnetic flux of 110.94 mWb. A magnetic flux of the magnet assembly MPb may be reduced by 20.66%. When the magnet assembly MPc according to FIG. 6C is heated at 120° C. for 2 hours and then cooled to 20° C., the magnet assembly MPc may have a magnetic flux of 137.74 mWb. A magnetic flux of the magnet assembly MPc may be reduced by 12.91%. When the magnet assembly MPd according to FIG. 7A is heated at 120° C. for 2 hours and then cooled to 20° C., the magnet assembly MPd may have a magnetic flux of 121.93 mWb. A magnetic flux of the magnet assembly MPd may be reduced by 6.45%. When the magnet assembly MPe according to FIG. 7B is heated at 120° C. for 2 hours and then cooled to 20° C., the magnet assembly MPe may have a magnetic flux of 114.54 mWb. A magnetic flux of the magnet assembly MPe may be reduced by 2.23%. From Experiment 7, it may be confirmed that a magnetic flux loss rate of the magnet assembly MP1 according to an embodiment of the present disclosure is the smallest.

As confirmed through Experiments 6 and 7, when viewed in the axial direction, since an area of the second magnet MG2 according to an embodiment of the present disclosure is equal to an area of each of the first magnets MG1-1, a magnetic flux loss rate of the magnet assembly MP1 due to eddy current may be reduced. Therefore, durability of the axial motor AM of FIG. 1 may be improved.

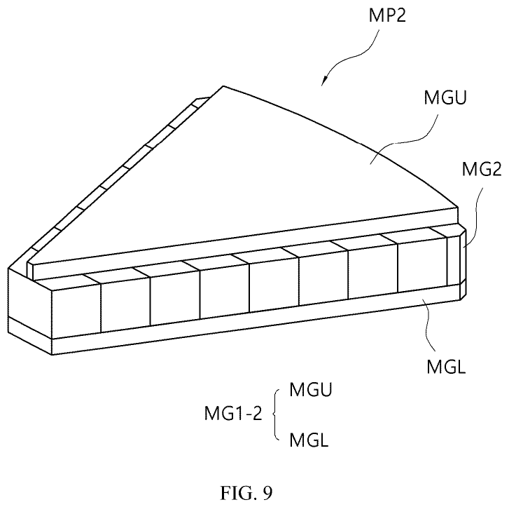

FIG. 9 is a perspective view of a magnet assembly according to an embodiment of the present disclosure.

Among components illustrated in FIG. 9, descriptions of components identical to those described above with reference to the foregoing drawings will be omitted or briefly described.

Referring to FIG. 9, a magnet assembly MP2 may include first magnets MG1-2 and a second magnet MG2. The second magnet MG2 may be disposed between the first magnets MG1-2.

The first magnets MG1-2 may include an upper magnet MGU and a lower magnet MGL. The upper magnet MGU and the lower magnet MGL may be arranged in the axial direction. The upper magnet MGU may be disposed on the second magnet MG2. For example, the upper magnet MGU may be disposed on an upper surface of the second magnet MG2. The lower magnet MGL may be disposed below the second magnet MG2. For example, the lower magnet MGL may be disposed on a lower surface of the second magnet MG2.

An area of one of the upper magnet MGU and the lower magnet MGL may be smaller than an area of the second magnet MG2, and an area of the other one of the upper magnet MGU and the lower magnet MGL may be equal to the area of the second magnet MG2. For example, as illustrated in FIG. 9, when viewed in the axial direction, an area of the upper magnet MGU may be smaller than an area of the second magnet MG2, and an area of the lower magnet MGL may be equal to the area of the second magnet MG2. However, the present disclosure is not limited thereto, and an area of the upper magnet MGU may be equal to the area of the second magnet MG2 while an area of the lower magnet MGL may be smaller than the area of the second magnet MG2.

When the rotor RT rotates, if a magnet assembly MP includes only a second magnet MG2, eddy current loss may occur in the second magnet MG2. Accordingly, a temperature of the second magnet MG2 may increase. Thereafter, when the second magnet MG2 is cooled, magnetic properties of the second magnet MG2 may be degraded.

In order to prevent such degradation, if the rotor RT includes a first magnet MG1 having a magnetic force relatively weaker than a magnetic force of the second magnet MG2, an overall magnetic force of the rotor RT may be insufficient. In addition, if a size of the first magnet MG1 is increased to enhance the magnetic force, a volume and a weight of the axial motor AM may be increased.

However, according to magnet assemblies MP of an embodiment of the present disclosure, first magnets MG1 may be disposed on an upper surface and a lower surface of a second magnet MG2. In this case, when viewed in a planar view, an area of the second magnet MG2 may be equal to an area of each of the first magnets MG1 or may be greater than the area of each of the first magnets MG1.

Accordingly, a reduction ratio of magnetic flux of the second magnet MG2 may be reduced by the first magnets MG1. Therefore, durability of the axial motor AM may be improved.

In addition, as the second magnet MG2 is disposed between the first magnets MG1, a reduction in magnetic force of the rotor RT may be prevented. Accordingly, an increase in volume and weight of the axial motor AM may be prevented.

Although embodiments of the present disclosure have been described, the technical spirit of the present disclosure is not limited to the embodiments presented herein. Those having ordinary skill in the art who understand the technical spirit of the present disclosure will readily appreciate that other embodiments may be easily devised through addition, modification, substitution, or deletion of components within the scope of the same inventive concept, and such embodiments should be construed as falling within the scope of the present disclosure.

### REFERENCE NUMERALS

| | |
|---|---|
| AM: axial motor | CV1: upper cover |
| CV2: lower cover | ST: stator |
| SC: stator cores | COP: coil assemblies |
| CL: coils | BK: brackets |
| AP: coupling structure | CO: core |
| BP: bars | MP: magnet assemblies |
| GP: guard | MG1: first magnets |
| MG2: second magnet | SMG: sub-magnets |

What is claimed is:

1. An axial motor comprising:
a plurality of stators arranged in an axial direction, each of the plurality of stators comprising a plurality of coil assemblies arranged along a circumferential direction intersecting the axial direction;
a rotor disposed between the plurality of stators; and
a shaft extending in the axial direction and penetrating the plurality of stators and the rotor,
wherein the rotor comprises:
a coupling structure comprising a core coupled to the shaft; and
a plurality of magnet assemblies coupled to the coupling structure and arranged along the circumferential direction, each of the plurality of magnet assemblies comprising a plurality of first magnets arranged in the axial direction and a plurality of second magnets disposed between the plurality of first magnets,
wherein side surfaces of each of the plurality of second magnets are exposed to an outside from the plurality of first magnets.

2. The axial motor of claim 1, wherein each of the plurality of second magnets comprises k sub-magnets arranged in an order of increasing distance from the core, and k is a natural number greater than 1.

3. The axial motor of claim 2, wherein an area of a k-th sub-magnet of the plurality of second magnets is greater than an area of a (k−1)-th sub-magnet of the plurality of second magnets when viewed in the axial direction.

4. The axial motor of claim 2, wherein an area of each of the plurality of second magnets is equal to an area of each of the plurality of first magnets when viewed in the axial direction.

5. The axial motor of claim 4, wherein peripheries of the plurality of second magnets and peripheries of the plurality of first magnets are aligned with each other when viewed in the axial direction.

6. The axial motor of claim 2, wherein an area of each of the plurality of second magnets is greater than an area of each of the plurality of first magnets when viewed in the axial direction.

7. The axial motor of claim 6, wherein peripheries of the plurality of second magnets are disposed outward of peripheries of the plurality of first magnets when viewed in the axial direction.

8. The axial motor of claim 2, wherein an area of a first one of the plurality of first magnets is smaller than an area of each of the plurality of second magnets, and an area of a second one of the plurality of first magnets is equal to the area of each of the plurality of second magnets when viewed in the axial direction.

9. The axial motor of claim 1, further comprising:
an upper cover defining a receiving space accommodating the shaft, the plurality of stators, and the rotor; and
a lower cover arranged in the axial direction with respect to the upper cover,
wherein the shaft is rotatably coupled to the upper cover and the lower cover.

10. The axial motor of claim 1, further comprising:
a plurality of bearings disposed between the plurality of stators and arranged in the axial direction,
wherein the rotor is disposed between the plurality of bearings.

11. The axial motor of claim 1, wherein the plurality of magnet assemblies are arranged along the circumferential direction, and the plurality of second magnets of the plurality of magnet assemblies adjacent to each other have different polarities.

12. An axial motor comprising:
a plurality of stators spaced apart from each other in an axial direction, each of the plurality of stators comprising a plurality of coil assemblies arranged along a circumferential direction intersecting the axial direction;
a shaft extending in the axial direction and coupled to the plurality of stators; and
a rotor coupled to the shaft and disposed between the plurality of stators,
wherein the rotor comprises:
a coupling structure coupled to the shaft; and
a plurality of magnet assemblies coupled to the coupling structure and arranged along the circumferential direction, each of the plurality of magnet assemblies comprising a plurality of first magnets arranged in the axial direction and a second magnet disposed between the plurality of first magnets,
wherein an area of the second magnet is greater than an area of each of the plurality of first magnets when viewed in the axial direction.

13. The axial motor of claim 12, wherein the second magnet includes k sub-magnets arranged in an order of increasing distance from the shaft, and k is a natural number greater than 1.

14. The axial motor of claim 13, wherein a periphery of the second magnet is disposed outward of peripheries of the plurality of first magnets when viewed in the axial direction.
